(19) United States
(12) Patent Application Publication
(10) Pub. No.: US 2025/0047227 A1
(43) Pub. Date: Feb. 6, 2025

(54) SEMICONDUCTOR INTEGRATED CIRCUIT DEVICE AND MOTOR SYSTEM

(71) Applicant: ROHM CO., LTD., Kyoto (JP)

(72) Inventor: Tatsuji NAKAI, Kyoto (JP)

(21) Appl. No.: 18/793,183

(22) Filed: Aug. 2, 2024

(30) Foreign Application Priority Data
Aug. 4, 2023 (JP) 2023-127990

(51) Int. Cl. H02P 27/04; H02P 25/066

(52) U.S. Cl. CPC H02P 27/04; H02P 25/066

(57) ABSTRACT

A semiconductor integrated circuit device includes: a first terminal configured to receive a first voltage; a part of a charge pump circuit configured to output a second voltage obtained by stepping down the first voltage received from the first terminal; at least a part of a linear power supply circuit configured to output a third voltage obtained by stepping down the second voltage received from the charge pump circuit; an internal circuit configured to use the third voltage received from the linear power supply circuit as a power supply voltage; a second terminal configured such that a first end of an external resistor included in the charge pump circuit is connected to the second terminal; and a third terminal configured such that a second end of the external resistor is connected to the third terminal.

### CROSS-REFERENCE TO RELATED APPLICATION

This application is based upon and claims the benefit of priority from Japanese Patent Application No. 2023-127990, filed on Aug. 4, 2023, the entire contents of which are incorporated herein by reference.

### TECHNICAL FIELD

The present disclosure relates to a semiconductor integrated circuit device and a motor system.

### BACKGROUND

In a motor drive device (semiconductor integrated circuit device) disclosed in the related art, an internal power supply circuit generates an internal power supply voltage from a power supply voltage and supplies the same to each part of the motor drive device (logic circuit, etc.).

### BRIEF DESCRIPTION OF DRAWINGS

The accompanying drawings, which are incorporated in and constitute a part of the specification, illustrate embodiments of the present disclosure.

FIG. 1 is a diagram showing a schematic configuration of a motor system according to a first embodiment of the present disclosure.

FIG. 2 is an external perspective view of a semiconductor integrated circuit device.

FIG. 3 is a timing chart for explaining an operation of the semiconductor integrated circuit device according to the first embodiment.

FIG. 4 is a timing chart for explaining another operation of the semiconductor integrated circuit device according to the first embodiment.

FIG. 5 is a timing chart for explaining yet another operation of the semiconductor integrated circuit device according to the first embodiment.

FIG. 6 a diagram showing a relationship between a voltage applied to a terminal VB and power consumption of the semiconductor integrated circuit device.

FIG. 7 is a diagram showing a schematic configuration of a motor system according to a second embodiment of the present disclosure.

FIG. 8 is a diagram showing a schematic configuration of a motor system according to a third embodiment of the present disclosure.

FIG. 9 is a diagram showing a schematic configuration of a motor system according to a fourth embodiment of the present disclosure.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

In the present disclosure, a metal-oxide-semiconductor field effect transistor (MOSFET) refers to a field effect transistor having a gate structure constituted by at least three layers selected from the group of a “layer made of a conductor or a semiconductor such as polysilicon with a low resistance value,” an “insulating layer,” and a “P-type, N-type, or intrinsic semiconductor layer.” That is, the gate structure of the MOSFET is not limited to a three-layer structure of metal, oxide, and semiconductor.

In the present disclosure, a reference voltage means a voltage that is constant in an ideal state, and is actually a voltage that may vary slightly due to a change in temperature or the like.

### First Embodiment

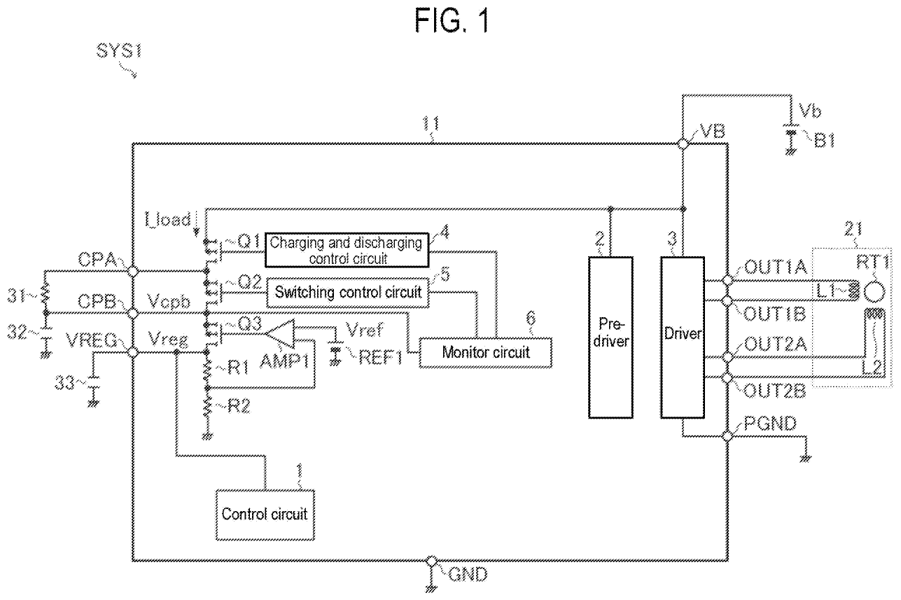

FIG. 1 is a diagram showing a schematic configuration of a motor system according to a first embodiment of the present disclosure. A motor system SYS1 shown in FIG. 1 includes a semiconductor integrated circuit device 11, a motor 21, a resistor 31, and capacitors 32 and 33.

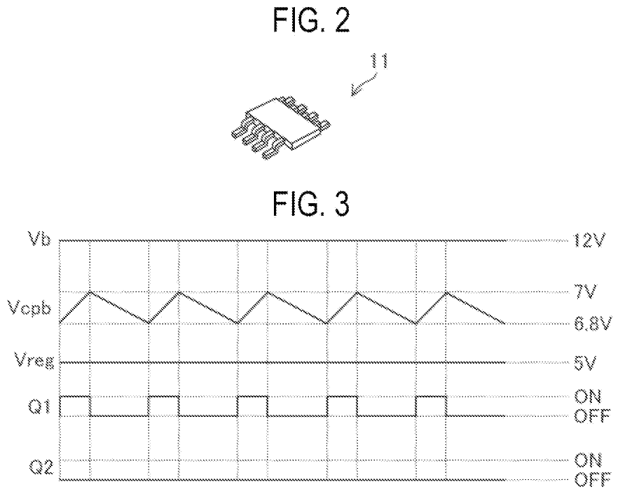

FIG. 2 is an external perspective view of the semiconductor integrated circuit device 11. The semiconductor integrated circuit device 11 is an electronic component formed by sealing a semiconductor integrated circuit chip in a housing (package) made of resin. A plurality of external terminals are provided to be exposed on the housing of the semiconductor integrated circuit device 11, and the plurality of external terminals include terminals VB, CPA, CPB, VREG, OUT1A, OUT1B, OUT2A, OUT2B, PGND, and GND shown in FIG. 1. The number of external terminals of the semiconductor integrated circuit device 11 and an appearance of the semiconductor integrated circuit device 11 shown in FIG. 2 are merely examples.

The semiconductor integrated circuit device 11 includes a control circuit 1, a pre-driver 2, a driver 3, and the terminals VB, OUT1A, OUT1B, OUT2A, OUT2B, PGND, and GND.

The control circuit 1 includes a control logic circuit and an analog circuit and controls the driver 3 via the pre-driver 2.

The pre-driver 2 performs predetermined signal processing (level shift processing, waveform shaping processing, simultaneous on prohibition processing, etc.) on upper/lower pre-driver drive signals for each phase supplied from the control circuit 1, thereby generating upper/lower driver drive signals for each phase and outputting the same to the driver 3.

The driver 3 generates a motor drive voltage for each phase based on the upper/lower driver drive signals for each phase supplied from the pre-driver 2 and outputs the same to the motor 21. The motor 21 is a two-phase stepping motor. The motor 21 includes a rotor RT1 and stator coils L1 and L2 respectively corresponding to two phases. The driver 3 is connected to a first end of the stator coil L1 via the terminal OUT1A, to a second end of the stator coil L1 via the terminal OUT1B, to a first end of the stator coil L2 via the terminal OUT2A, and to a second end of the stator coil L2 via the terminal OUT2B.

A voltage Vb is applied to the terminal VB from a voltage source B1. The pre-driver 2 and the driver 3 are configured to use the voltage Vb, which is received from the terminal VB, as a power supply voltage.

A ground potential is applied to the terminal PGND. The driver 3 is configured to use the ground potential, which is received from the terminal PGND, as a reference potential.

The ground potential is applied to the terminal GND. The ground potential applied to the terminal GND is used as a reference potential in each part of the semiconductor integrated circuit device 11.

The semiconductor integrated circuit device 11 further includes transistors Q1 to Q3, which are P-channel MOSFETs, resistors R1 and R2, an amplifier AMP1, a reference voltage source REF1, a charging and discharging control circuit 4, a switching control circuit 5, a monitor circuit 6, and the terminals CPA, CPB, and VREG.

A source of the transistor Q1 is connected to the terminal VB. A drain of the transistor Q1 is connected to the terminal CPA and a source of the transistor Q2. A drain of the transistor Q2 is connected to the terminal CPB and a source of the transistor Q3. A voltage Vreg at a drain of the transistor Q3 is supplied to the terminal VREG, a voltage divider circuit including the resistors R1 and R2, and the control circuit 1.

The charging and discharging control circuit 4 controls the transistor Q1. The switching control circuit 5 controls the transistor Q2. The monitor circuit 6 monitors a voltage Vcpb of the terminal CPB and outputs a monitoring result to the charging and discharging control circuit 4 and the switching control circuit 5.

The amplifier AMP1 controls the transistor Q3 according to a difference between a reference voltage Vref, which is output from the reference voltage source REF1, and the voltage Vreg.

Outside the semiconductor integrated circuit device 11, a first end of the resistor 31 is connected to the terminal CPA, a second end of the resistor 31 and a first end of the capacitor 32 are connected to the terminal CPB, a first end of the capacitor 33 is connected to the terminal VREG, and a second end of the capacitor 32 and a second end of the capacitor 33 are connected to the ground potential.

A charge pump circuit including the transistors Q1 and Q2, the resistor 31, and the capacitor 32 is configured to output the voltage Vcpb obtained by stepping down the Vb received from the terminal VB.

A linear power supply circuit including the transistor Q3, the resistors R1 and R2, the amplifier AMP1, and the capacitor 33 is configured to output the voltage Vreg obtained by stepping down the voltage Vcpb.

FIG. 3 is a timing chart for explaining an operation of the semiconductor integrated circuit device 11. In FIG. 3, the voltages Vb, Vcpb, and Vreg, a state of the transistor Q1, and a state of the transistor Q2 are depicted from top to bottom. The voltage values depicted in FIG. 3 are merely examples and are not limited thereto.

When the voltage Vcpb falls to a first threshold value (for example, 6.8 V), the charging and discharging control circuit 4 turns on the transistor Q1, and when the voltage Vcpb rises to a second threshold value (for example, 7 V) that is larger than the first threshold value, the charging and discharging control circuit 4 turns off the transistor Q1.

When the transistor Q1 is turned on, the capacitor 32 is charged and the voltage Vcpb rises, and when the transistor Q1 is turned off, the capacitor 32 is discharged and the voltage Vcpb falls. In the timing chart shown in FIG. 3, since the transistor Q2 is turned off, the power supplied to the terminal VB is distributed and consumed inside the semiconductor integrated circuit device 11 and the resistor 31. This reduces the power consumption inside the semiconductor integrated circuit device 11 and can suppress heat generation inside the semiconductor integrated circuit device 11. In this way, since the semiconductor integrated circuit device 11 can suppress heat generation inside the semiconductor integrated circuit device 11, an output current capacity of the driver 3 can be improved.

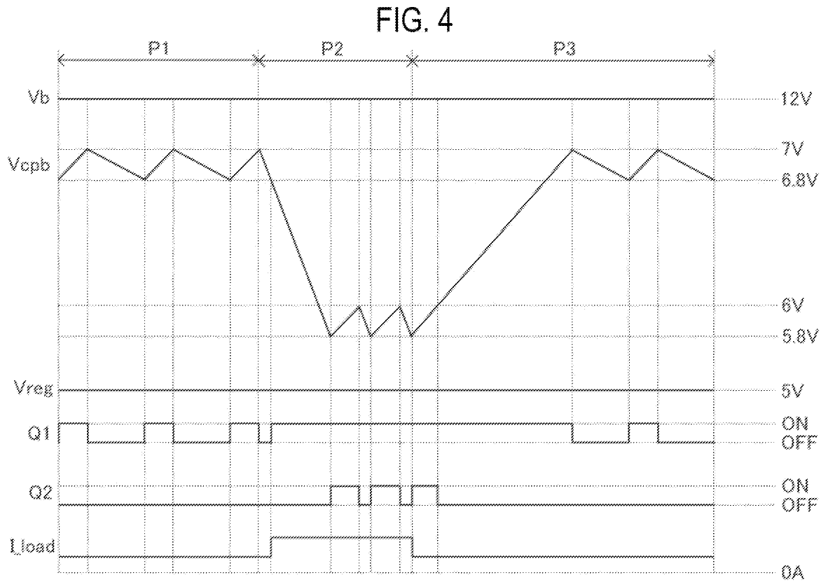

FIG. 4 is a timing chart for explaining another operation of the semiconductor integrated circuit device 11. In FIG. 4, the voltage Vb, the voltage Vcpb, the voltage Vreg, the state of the transistor Q1, the state of the transistor Q2, and a current I_load flowing through the transistor Q1 are depicted from top to bottom. The voltage values depicted in FIG. 4 are merely examples and are not limited thereto.

In FIG. 4, transition is made in the order of a period P1, a period P2, and a period P3. The periods Pl and P3 are periods during which a load driven by the power output from the linear power supply circuit including the transistor Q3, the resistors R1 and R2, the amplifier AMP1, and the capacitor 33 is light. The period P2 is a period during which the load driven by the power output from the linear power supply circuit including the transistor Q3, the resistors R1 and R2, the amplifier AMP1, and the capacitor 33 is heavy. For example, when a variable load is externally connected to the terminal VREG, the semiconductor integrated circuit device 11 may operate as shown in FIG. 4.

The operation of the semiconductor integrated circuit device 11 during the period P1 is the same as that shown in FIG. 3.

During the period P2, even when the transistor Q1 is turned on, the voltage Vcpb continues to fall. When the voltage Vcpb falls to a third threshold value (for example, 5.8 V) that is smaller than the first threshold value, the switching control circuit 5 turns on the transistor Q2. As a result, the terminals CPA and CPB are short-circuited to decrease the resistance values of the terminals CPA and CPB, making it possible to improve a charging capacity of the charge pump circuit and to increase the voltage Vcpb as compared to a state in which the terminals CPA and CPB are not short-circuited.

When the voltage Vcpb rises to a fourth threshold value (for example, 6 V) that is larger than the third threshold value and smaller than the first threshold value, the switching control circuit 5 turns off the transistor Q2. As a result, the charging ability of the charge pump circuit is reduced as compared to the state in which the terminals CPA and CPB are short-circuited, which decreases the voltage Vepb during the period P2 but increases the voltage Vcpb during the period P3.

In other words, by providing a switching circuit (the transistor Q2 in the present embodiment) configured to switch between short-circuit and non-short-circuit between the terminals CPA and CPB, the charge pump circuit can cope with a larger load. In cases where the charge pump circuit does not need to cope with a larger load, the charge pump circuit may not include the switching circuit (the transistor Q2 in the present embodiment) configured to switch between short-circuit and non-short-circuit between the terminals CPA and CPB.

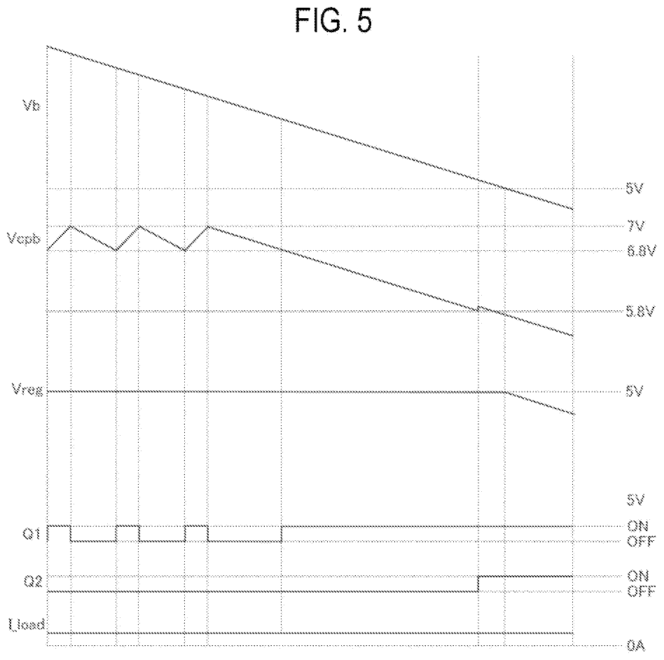

FIG. 5 is a timing chart for explaining yet another operation of the semiconductor integrated circuit device 11. In FIG. 5, the voltage Vb, the voltage Vcpb, the voltage Vreg, the state of the transistor Q1, the state of the transistor Q2, and the current I_load flowing through the transistor Q1 are depicted from top to bottom. The voltage values depicted in FIG. 5 are merely examples and are not limited thereto.

In FIG. 5, the voltage Vb gradually falls (decreases). When the voltage Vb falls below the first threshold value (for example, 6.8 V), the voltage Vcpb does not rise even when the transistor Q1 is turned on. When the voltage Vepb falls to the third threshold value (for example, 5.8 V) that is smaller than the first threshold value, the switching control circuit 5 turns on the transistor Q2. As a result, the terminals CPA and CPB are short-circuited to decrease the resistance values of the terminals CPA and CPB, making it possible to improve the charging capacity of the charge pump circuit and to suppress a decrease in the voltage Vcpb as compared to a state in which the terminals CPA and CPB are not short-circuited.

When the voltage Vb falls below a target output voltage (for example, 5 V) of the linear power supply circuit including the transistor Q3, the resistors R1 and R2, the amplifier AMP1, and the capacitor 33, the output voltage Vreg of the linear power supply circuit including the transistor Q3, the resistors R1 and R2, the amplifier AMP1, and the capacitor 33 becomes lower than the target output voltage.

By providing the switching circuit (the transistor Q2 in the present embodiment) configured to switch between short-circuit and non-short-circuit between the terminals CPA and CPB, it is possible to improve resistance of the voltage Vb to a decrease in voltage.

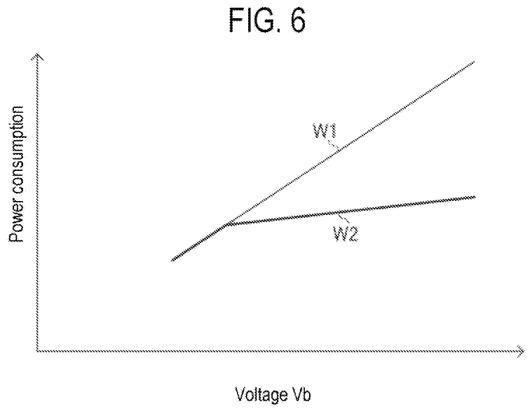

FIG. 6 is a diagram showing a relationship between the voltage Vb applied to the terminal VB and the power consumption of the semiconductor integrated circuit device 11. In FIG. 6, a horizontal axis represents the voltage Vb applied to the terminal VB, and a vertical axis represents the power consumption.

A thin solid line W1 in FIG. 6 indicates the power supplied to the terminal VB, that is, the power consumption of the semiconductor integrated circuit device 11 and the resistor 31. A thick solid line W2 in FIG. 6 indicates the power consumption of the semiconductor integrated circuit device 11.

When the transistor Q2 is turned on, the thin solid line W1 in FIG. 6 coincides with the thick solid line W2 in FIG. 6.

When the transistor Q2 is turned off, the power consumption of the semiconductor integrated circuit device 11 becomes smaller than the power supplied to the terminal VB, and a difference between the thin solid line W1 in FIG. 6 and the thick solid line W2 in FIG. 6 is the power consumed by the resistor 31.

### Second Embodiment

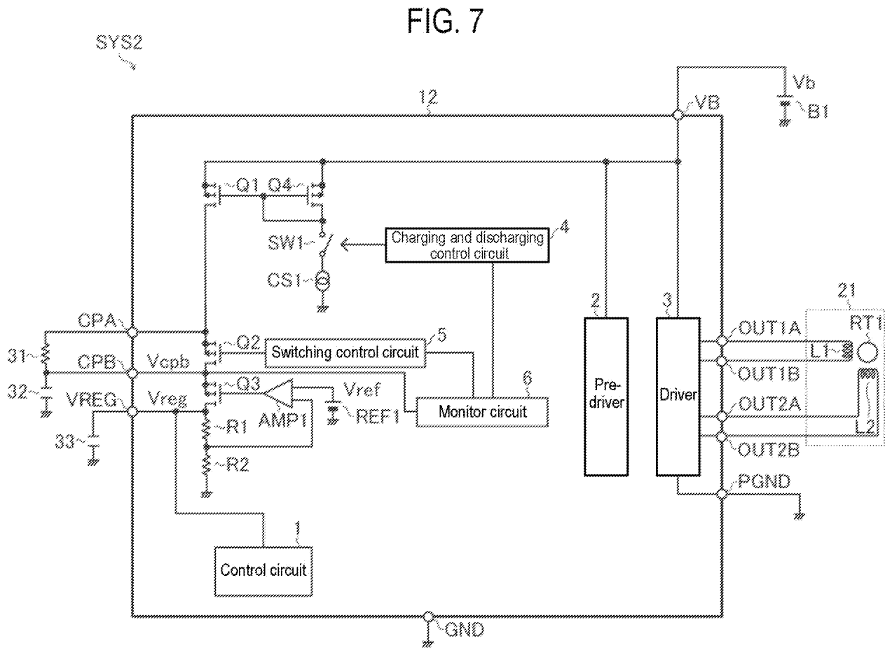

FIG. 7 is a diagram showing a schematic configuration of a motor system according to a second embodiment of the present disclosure. The motor system SYS2 shown in FIG. 7 includes a semiconductor integrated circuit device 12, a motor 21, a resistor 31, and capacitors 32 and 33.

The semiconductor integrated circuit device 12 has a configuration where a transistor Q4, which is a P-channel MOSFET, a switch SW1 controlled by the charging and discharging control circuit 4, and a current source CS1 are added to the semiconductor integrated circuit device 11. The transistors Q1 and Q4 constitute a current mirror circuit. When the switch SW1 is on, the current mirror circuit constituted by the transistors Q1 and Q4 supplies a mirror current, which mirrors an output current of the current source CS1, to the terminal CPA.

In the present embodiment, the transistor Q1 functions as a current source. That is, in the present embodiment, the current source is connected to the terminal CPA. Consequently, a change in the voltage of the terminal CPA becomes less steep, thereby reducing ripples of the voltage Vreg. In FIGS. 3 to 5 of the above-described first embodiment, the waveform of the voltage Vreg is simplified and an illustration of the ripples of the voltage Vreg is omitted.

Similar to the semiconductor integrated circuit device 11, the semiconductor integrated circuit device 12 can suppress heat generation inside the semiconductor integrated circuit device 12.

### Third Embodiment

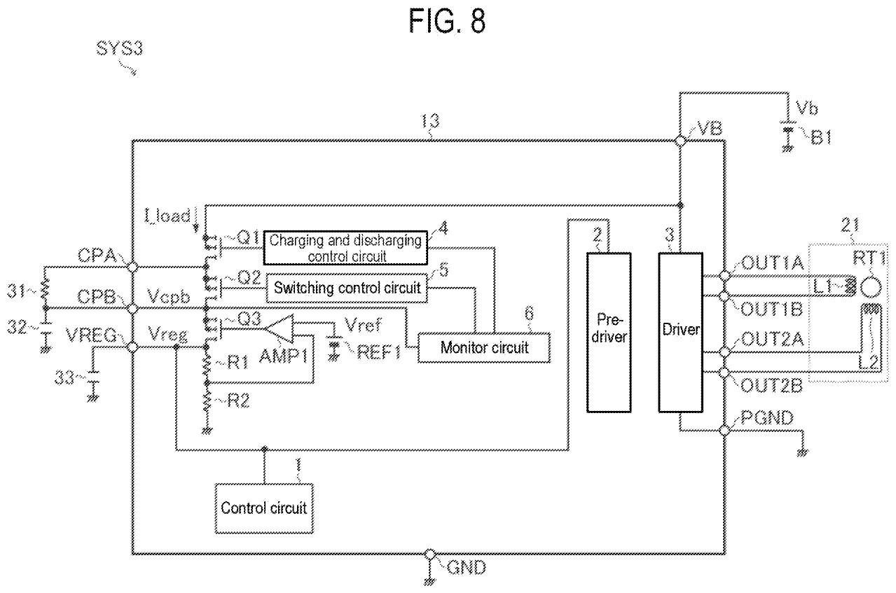

FIG. 8 is a diagram showing a schematic configuration of a motor system according to a third embodiment of the present disclosure. The motor system SYS3 shown in FIG. 8 includes a semiconductor integrated circuit device 13, a motor 21, a resistor 31, and capacitors 32 and 33.

The semiconductor integrated circuit device 13 is different from the semiconductor integrated circuit device 11 in that the pre-driver 2 is configured to use the voltage Vreg as a power source voltage, but is otherwise similar to the semiconductor integrated circuit device 11.

Similar to the semiconductor integrated circuit device 11, the semiconductor integrated circuit device 13 can suppress heat generation inside the semiconductor integrated circuit device 13.

### Fourth Embodiment

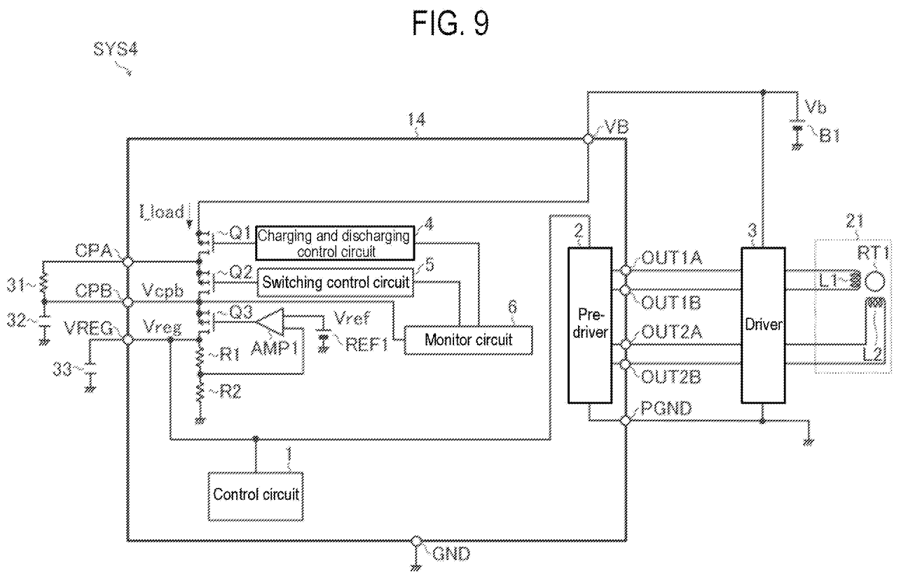

FIG. 9 is a diagram showing a schematic configuration of a motor system according to a fourth embodiment of the present disclosure. The motor system SYS4 shown in FIG. 9 includes a semiconductor integrated circuit device 14, a motor 21, a resistor 31, capacitors 32 and 33, and a driver 3.

The semiconductor integrated circuit device 14 is different from the semiconductor integrated circuit device 13 in that the driver 3 is connected externally, but is otherwise similar to the semiconductor integrated circuit device 13.

Similar to the semiconductor integrated circuit device 11, the semiconductor integrated circuit device 14 can suppress heat generation inside the semiconductor integrated circuit device 14.

### Others

In addition to the above-described embodiments, various modifications can be made to the configuration of the present disclosure without departing from the spirit of the present disclosure. The above-described embodiments are illustrative in all respects and should not be considered as limiting, and the technical scope of the present disclosure is indicated by the claims, not the description of the above-described embodiments, and should be understood to include all modifications that fall within the meaning and scope equivalent to the claims.

For example, in the above-described various embodiments, the motor is a two-phase motor, but the motor may be a three-phase motor.

For example, in the above-described various embodiments, the pre-driver 2 uses the voltage Vb applied to the terminal VB as the power supply voltage, but a boost circuit configured to boost the voltage Vb applied to the terminal VB of the semiconductor integrated circuit device may be provided in the semiconductor integrated circuit device, and the pre-driver 2 may use a voltage, which is obtained by boosting the voltage Vb, as the power supply voltage.

### Supplementary Notes

Supplementary notes will be provided for the present disclosure in which specific configuration examples are shown in the above-described embodiments.

A semiconductor integrated circuit device (11 to 15) of the present disclosure has a configuration (first configuration) that it includes: a first terminal (VB) configured to receive a first voltage; a part (Q1, Q2) of a charge pump circuit configured to output a second voltage obtained by stepping down the first voltage received from the first terminal; at least a part (Q3, R1, R2, REF1, AMP1) of a linear power supply circuit configured to output a third voltage obtained by stepping down the second voltage received from the charge pump circuit; an internal circuit (1) configured to use the third voltage received from the linear power supply circuit as a power supply voltage; a second terminal (CPA) configured such that a first end of an external resistor included in the charge pump circuit is connected to the second terminal (CPA); and a third terminal (CPB) configured such that a second end of the external resistor is connected to the third terminal (CPB).

According to the semiconductor integrated circuit device of the first configuration, since the power supplied to the first terminal is distributed and consumed inside the semiconductor integrated circuit device and the external resistor, the power consumption inside the semiconductor integrated circuit device is reduced, and heat generation inside the semiconductor integrated circuit device can be suppressed.

The semiconductor integrated circuit device of the first configuration may have a configuration (second configuration) that it further includes an output stage (2, 3) configured to use the first voltage received from the first terminal as a power supply voltage.

The semiconductor integrated circuit device of the first or second configuration may have a configuration (third configuration) that the charge pump circuit includes a switching circuit (Q2) configured to switch between short-circuit and non-short-circuit between the second terminal and the third terminal.

The semiconductor integrated circuit device of the third configuration may have a configuration (fourth configuration) that it further includes a switching control circuit (5) configured to control the switching circuit based on the second voltage.

The semiconductor integrated circuit device of the fourth configuration may have a configuration (fifth configuration) that the switching control circuit is configured to switch from the non-short-circuit to the short-circuit between the second terminal and the third terminal when the second voltage falls below a predetermined value.

The semiconductor integrated circuit device of any one of the first to fifth configurations may have a configuration (sixth configuration) that it further includes a charging and discharging control circuit (4) configured to control charging and discharging of a capacitor (32) included in the charge pump circuit based on the second voltage.

The semiconductor integrated circuit device of any one of the first to sixth configurations may have a configuration (seventh configuration) that it further includes a current source (Q1) connected to the second terminal.

The semiconductor integrated circuit device of the second configuration may have a configuration (eighth configuration) that the internal circuit includes a control circuit (1) configured to directly or indirectly control the output stage.

The semiconductor integrated circuit device of the eighth configuration may have a configuration (ninth configuration) that it further includes a pre-driver (2), wherein the control circuit is configured to indirectly control the output stage via the pre-driver, and the pre-driver is configured to use the first voltage received from the first terminal or a voltage obtained by boosting the first voltage as a power supply voltage.

The semiconductor integrated circuit device of the second configuration may have a configuration (tenth configuration) that it further includes: a control circuit (1) configured to indirectly control the output stage via a pre-driver, wherein the internal circuit includes the pre-driver.

The semiconductor integrated circuit device of the tenth configuration may have a configuration (eleventh configuration) that the internal circuit includes the control circuit.

A motor system (SYS1 to SYS5) of the present disclosure has a configuration (twelfth configuration) that it includes: a motor (21); and the semiconductor integrated circuit device of any one of the first to eleventh configurations configured to drive the motor.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A semiconductor integrated circuit device comprising:
a first terminal configured to receive a first voltage;
a part of a charge pump circuit configured to output a second voltage obtained by stepping down the first voltage received from the first terminal;
at least a part of a linear power supply circuit configured to output a third voltage obtained by stepping down the second voltage received from the charge pump circuit;
an internal circuit configured to use the third voltage received from the linear power supply circuit as a power supply voltage;
a second terminal configured such that a first end of an external resistor included in the charge pump circuit is connected to the second terminal; and
a third terminal configured such that a second end of the external resistor is connected to the third terminal.

2. The semiconductor integrated circuit device of claim 1, further comprising an output stage configured to use the first voltage received from the first terminal as a power supply voltage.

3. The semiconductor integrated circuit device of claim 1, wherein the charge pump circuit includes a switching circuit configured to switch between short-circuit and non-short-circuit between the second terminal and the third terminal.

4. The semiconductor integrated circuit device of claim 3, further comprising a switching control circuit configured to control the switching circuit based on the second voltage.

5. The semiconductor integrated circuit device of claim 4, wherein the switching control circuit is configured to switch from the non-short-circuit to the short-circuit between the second terminal and the third terminal when the second voltage falls below a predetermined value.

6. The semiconductor integrated circuit device of claim 1, further comprising a charging and discharging control circuit configured to control charging and discharging of a capacitor included in the charge pump circuit based on the second voltage.

7. The semiconductor integrated circuit device of claim 1, further comprising a current source connected to the second terminal.

8. The semiconductor integrated circuit device of claim 2, wherein the internal circuit includes a control circuit configured to directly or indirectly control the output stage.

9. The semiconductor integrated circuit device of claim 8, further comprising a pre-driver,
wherein the control circuit is configured to indirectly control the output stage via the pre-driver, and
wherein the pre-driver is configured to use the first voltage received from the first terminal or a voltage obtained by boosting the first voltage as a power supply voltage.

10. The semiconductor integrated circuit device of claim 2, further comprising a control circuit configured to indirectly control the output stage via a pre-driver,
wherein the internal circuit includes the pre-driver.

11. The semiconductor integrated circuit device of claim 10, wherein the internal circuit includes the control circuit.

12. A motor system comprising:
a motor; and
the semiconductor integrated circuit device of claim 1 configured to drive the motor.
